(19) United States
(12) Patent Application Publication
(10) Pub. No.: US 2004/0177673 A1
(43) Pub. Date: Sep. 16, 2004

(54) Apparatus and methods relating to humidified air and to sensing components of gas or vapour

(75) Inventors: Toby Trevor Fury Mottram, Royston (GB); Steven George Vass, Ampthill (GB); Colin John Houghton, Maulden (GB)

Correspondence Address: NIXON & VANDERHYE, PC, 1100 N GLEBE ROAD, 8TH FLOOR, ARLINGTON, VA, 22201-4714, US

(73) Assignee: BTG International Limited, London (GB)

(21) Appl. No.: 10/810,851

(22) Filed: Mar. 29, 2004

Related U.S. Application Data
(63) Continuation of application No. 09/828,203, filed on Apr. 9, 2001, now abandoned.

(30) Foreign Application Priority Data
Nov. 9, 1998 (GB) 9824556.6
Nov. 9, 1999 (WO) PCT/GB99/03726

(51) Int. Cl. G01N 7/00

(52) U.S. Cl. 73/23.2

(57) ABSTRACT

Apparatus (10) is shown for providing a flow of humidified air at a selected humidity level, and a method is disclosed of monitoring olfactory parameters of a sample gas or vapour to provide a “finger print” or profile of an odour. The flow of humidified air is used to set a level of humidity in a sensor chamber (36) which is the same as the level of humidity in a sample chamber (44) containing the sample of gas or vapour. The sample gas or vapour is then introduced into the sensor chamber (36), where an array of olfactory sensors record the odour profile, without a sudden change of humidity level when the sample gas or vapour is admitted. The flow of humidified air at a selected humidity level is obtained from a generator (10) having a controllable valve 14 for directing a clean dry air stream along either of two paths (17,18), one of which includes a humidifier 22. Air from the two paths is combined in a mixing chamber 21 and the humidity level is monitored by a sensor 23 with a feedback loop to control the valve 14. Sensors other than olfactory sensors, e.g. infrared sensors, may be used.

The present invention relates in a first aspect to an apparatus for and a method of providing a flow of humidified air having a selected humidity level. In a second aspect the invention relates to a method of and apparatus for monitoring one or more parameters or components of a sample gas or vapour. In a preferred form the present invention relates to the monitoring of an exhalation of a subject such as an animal or bird in order to provide information about the subject. The information can relate to health, diet or other condition. The subject can be a farm livestock animal such as a cow, or a domestic animal such a cat, dog or horse. The subject could also be a turkey or chicken.

Animals produce exhalations some of which are odours such as those from the skin, breath, milk and solid and liquid waste products. The term exhalation includes not only breath expelled by a subject, but also any emanation of gas or vapour derived from the subject. Exhalation includes breath from an animal, vapour from milk or any other volatile materials emanating from the animal. The condition of the animal can be determined from a component of the exhalation, which component may be an odour or specific compound or other material. The composition of such an exhalation can provide a valuable source of information regarding the animals state of health.

However it is to be appreciated that in its first aspect the invention relates broadly to apparatus for providing humidified air, and may be used in any application where humidified air is required. Similarly in its second aspect the invention relates to measuring one or more parameters or components of any sample gas or vapour. The invention in its second aspect embraces the use of any sensor whose performance is affected by humidity. Examples of such sensors are olfactory sensors as used in a so called “electronic nose”, and infrared absorption spectrum sensors. Other types of sensors which are affected by humidity will be apparent to those skilled in this art. The use of the invention in monitoring animal exhalation samples is merely a preferred application of the invention.

Examples of “electronic noses” may be found in GB-A-2 272 773 (British Technology Group Limited), U.S. Pat. No. 4,202,352 (Osborne), and EP-A-0 650 051 (Kyoto Dai-Ischi Kagaku Co., Ltd.). The olfactory sensors may be arranged to create as an output, patterns which give a “finger print” of the odour being analysed. The sensors utilised in the present invention may be of the kind described in a paper entitled “Multi Element Arrays for Sensing Volatile Chemicals” by Krishna C. Persaud and Paul Travers, Intelligent Instruments Computers, July/August 1991, or other devices subsequently developed. The paper referred to gives an overview of the types of olfactory sensors available, and the principles of operation thereof.

A main problem which has been found in the use of an electronic nose, and in the use of infrared sensors for analysing gas/vapour components, is that the sensors are extremely sensitive to variations in humidity of the sample. The human or animal nose operates in a controlled humidity environment, in that the receptors are positioned under a layer of mucus, so that odours which are sensed penetrate through a mucus layer. This keeps the human or animal sensors at a stable humidity. Although attempts have been made in the use of electronic noses to supply the sample at a standardised humidity, this has in practice not been controlled sufficiently accurately. It is often found that an apparently strong signal detected by the electronic nose can be attributed mainly to a change in humidity between a flushing gas, without odour, used for calibration, and a test sample, where the humidity has been increased due to the presence of the sample. Put simply, the presence of a genuine “finger print” of an odour, is swamped by a change in humidity during the analysing and measurement of the sample.

Returning to consideration of the first aspect of the invention, attempts have been made previously to supply humidified air having a selected predetermined humidity, but these have been provided by mixing together a dry air stream and a wet air stream in accordance with predetermined ratios, which have been previously tested against a resulting humidity, and which are supposed therefore to reproduce that level of humidity. Essentially previous commercially available apparatus for providing humidified air at a selected humidity level have merely operated by the electronic equivalent of “look-up tables”, without any accurate monitoring and adjustment to ensure that the output humidified air stream is at the required level of humidity.

In accordance with the first aspect of the invention, it is an object of the invention to provide apparatus for providing humidified air at a selected level of humidity of greater accuracy and stability than has previously been possible. In the second aspect of the invention, it is an object of the invention to provide a more accurate and dependable apparatus and method for monitoring parameters or components of a sample, for example an exhalation of an animal.

In WO 97/00444 (British Technology Group Limited) there is disclosed apparatus for monitoring animal exhalation, to provide an indication of the condition of an animal. In one arrangement, the animal exhalation is pumped to a mixing chamber in which it is combined with a stream of humidified air and the mixture is then pumped to a sensing chamber including a sensor array. The stream of humidified air is obtained from air passing from a humidifier and a dryer, the streams being combined together in a valve which controls the relative proportions of dried and humidified gas reaching the mixing chamber. The temperature and humidity of the sample in the sensing chamber is monitored by temperature and humidity sensors.

In accordance with the invention in a first aspect there is provided apparatus for providing a flow of humidified air having a selected humidity level, comprising:

supply means for supplying a first air stream and a second air stream to be combined together, the second air stream having a higher humidity than the first air stream,

a humidity sensor for sensing the humidity of air combined from the first and second air streams, and

control means for varying the proportions in which the first and second air streams are combined in response to a humidity level signal from the humidity sensor so as to maintain the humidity of the combined air at a selected humidity.

In a particularly preferred form, the supply means comprises input means for supplying an input stream of air, and a controllable valve for directing air from the input means to a first air flow path and to a second air flow path, the second air flow path including humidifying means for increasing the humidity of the air in the second air flow path, and the valve being controllable to vary the amount of air directed to each of the air flow paths, the control means being arranged to control the valve in response to said humidity level signal from the humidity sensor so as to maintain the humidity of the combined air at a selected humidity.

The controllable valve may comprise a proportional, analogue valve, in which the input stream of air is divided and directed partly into the first air flow path and partly into the second air flow path, the controllable valve varying the proportions of air directed into the two paths. However it is preferred that the controllable valve is a multistate valve, for example a two way valve, in which the whole of the input air flow is directed to one of the air flow paths at any one time. Preferably the controllable valve has a first state arranged to direct the entire input stream of air to the first air flow path and a second state arranged to direct the entire input stream of air to the second air flow path, the control means being arranged to switch the valve between states and to vary the time periods of the two states to achieve the variation in proportion in which the first and second air streams are combined.

Conveniently the humidifying means in the second air flow path comprises means for contacting the air stream with water, for example by bubbling the air stream through water. It is found that this introduces a greater resistance to flow through the second air flow path than through the first. In accordance with a further feature of the invention the first air flow path includes a flow restrictor. In some arrangements the flow restrictor is variable, over a range including a restriction sufficient to balance the air flows in the first and second air flow paths. In other arrangements the flow restrictor is a fixed restrictor, introducing an air flow restriction approximately equal to the air flow restriction introduced by the humidifying means in the second air flow path.

The provision of the flow restrictor is particularly advantageous in arrangements where the controllable valve is a multistate device as set out above. If the restrictor is not present, it may be found that the controllable valve is set by the control means to be predominantly in the second state, with occasional supply through the first air flow path. Such a situation can produce irregular operation of the humidity sensor due to the effect of a sudden substantial air flow from the first air flow path. Consequently, it is preferred that the air flow restrictor has a fixed value, or is adjusted to a value, such that the time periods of the valve in the two states are of the same order of magnitude, for example to differ from each other by no more than a multiple of two, when the humidity sensed by the humidity sensor is close to a required level set by the control means. Preferably the arrangement is such that the time periods in the two states are approximately the same. Although the combination of the two air streams may be made in a number of different arrangements, for example in a conduit, it is preferred that there is provided a mixing vessel connected to receive air from the first air stream and the second air stream only, the mixing vessel having an outlet for supplying combined air to further apparatus, and the humidity sensor being mounted to sense the humidity of air in the mixing vessel.

Conveniently the said control means comprises a microprocessor connected to receive the said humidity level signal from the humidity sensor. The control means may include a proportional integral differential controller for controlling the valve in response to the said humidity level signal from the humidity sensor.

In a particularly preferred application of this aspect of the invention, there is provided an assembly for monitoring one or more olfactory parameters of a sample placed in a sensor chamber including one or more olfactory sensors, for example an array of sensors for producing a profile of the odour of a sample placed in the chamber. In such an arrangement the assembly may include apparatus for providing a flow of humidified air, such as has been set out in previous paragraphs.

It is to be appreciated that where features of the invention are set out herein with regard to apparatus according to the invention in this aspect, such features may also be provided with regard to a method according to the invention, and vice versa.

In particular, there is provided in accordance with the invention a method of providing humidified air comprising:

supplying a first air stream and a second air stream, the second air stream having a higher humidity than the first air stream,

combining air from the two air streams,

sensing the relative humidity of the combined air, and

varying the proportions in which the first and second air streams are combined in response to the said sensed humidity of the combined air, in such a manner as to maintain the humidity of the combined air at a selected humidity.

In a particularly preferred arrangement, the method includes supplying an input air stream to a controllable valve for directing air from the input air stream to a first air flow path and to a second air flow path, the valve being controllable to vary the amount of air directed to each of the air flow paths, increasing the humidity of the air in the second air flow path, and controlling the valve in response to the said sensed humidity of the combined air, in such a manner as to maintain the humidity of the combined air at a selected humidity.

A second aspect of the invention is concerned with the monitoring of one or more components or parameters, e.g. olfactory parameters, of a sample gas or vapour. In accordance with this aspect of the invention there is provided a method of monitoring one or more components or parameters of a sample gas or vapour comprising the steps of

measuring the humidity of the sample gas or vapour, e.g. in a sample chamber,

providing a sensor chamber containing one or more sensors, e.g. olfactory sensors,

adjusting the humidity in the sensor chamber to be the same as the measured humidity of the sample gas or vapour,

admitting into the sensor chamber the sample gas or vapour at the same humidity level as the air in the sensor chamber, and

monitoring the output of the sensor or sensors,

Preferably, a flow of humidified air at a selected level of humidity is provided, in which case this flow of humidified air is passed through the sensor chamber.

In a preferred form, the step of providing a supply of humidified air in the sensor chamber comprises generating a stream of humidified air from apparatus including a first humidity sensor for sensing the humidity of the air generated, and control means operable to vary the humidity of the generated air supply and to adjust the humidity of the output air supply to be equal to a predetermined humidity level entered into the control means. The humidified air stream may be provided by the steps of the method of the first aspect of the invention, as set out above.

Conveniently the step of adjusting the humidity in the sensor chamber includes measuring the humidity in the sensor chamber by a second humidity sensor, and varying the humidity of the said supply of humidified air until the humidity levels measured on the first and second humidity sensors are the same as the said measured humidity of the sensor chamber. Also conveniently the step of measuring the humidity of the sample gas or vapour in the sample chamber is carried out by use of a third humidity sensor mounted for measuring the humidity in the sample chamber.

It is to be appreciated that where features of the invention in the second aspect are set out herein with regard to a method according to the invention, such features may also be provided with regard to apparatus according to the invention, and vice versa.

In particular there is provided in accordance with the invention apparatus for monitoring one or more olfactory parameters of the sample gas or vapour comprising

optionally, a sample chamber for a sample gas or vapour,

means for measuring the humidity of the sample gas or vapour,

apparatus for providing a flow of humidified air having a selected level of humidity,

a device for passing humidified air through a sensor chamber containing one or more sensors, at a selected level of humidity such that the humidity in the sensor chamber is adjusted to be the same as the measured humidity of the sample gas or vapour,

a valve, which may also constitute the device for passing humidified air through the chamber, for admitting into the sensor chamber the sample gas or vapour at the same humidity level as the air in the sensor chamber for monitoring of one or more components or parameters by the sensor or sensors.

Embodiments of the invention will now be described by way of example with reference to the accompanying drawings in which:

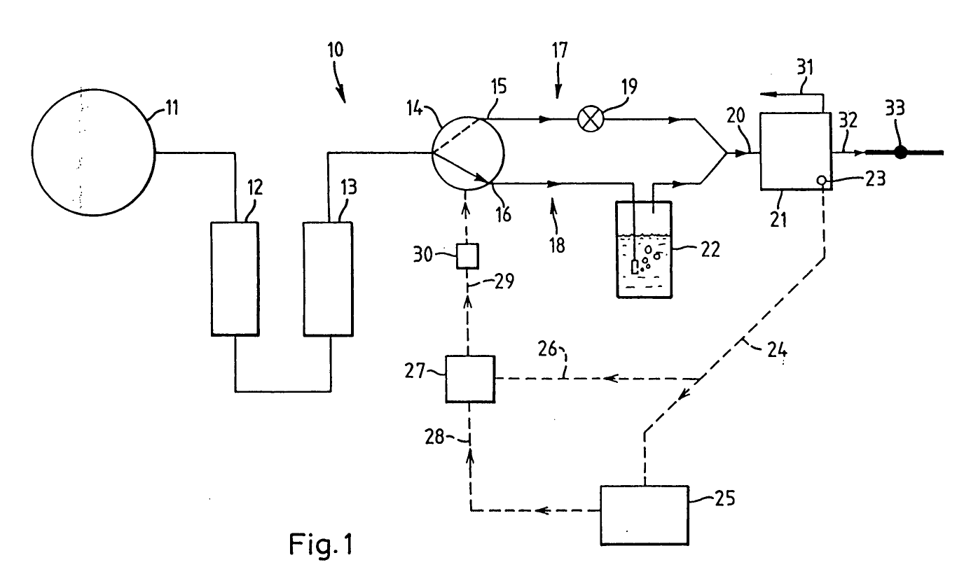

FIG. 1 is a block circuit diagram of apparatus for providing a flow of humidified air having a selected humidity level, embodying the present invention in its first aspect;

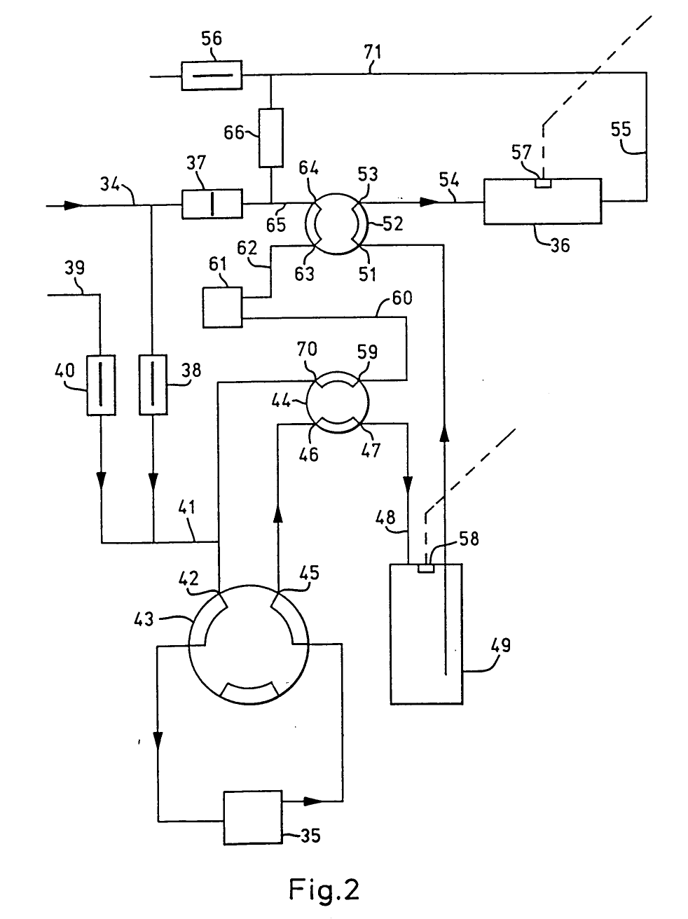

FIG. 2 is a block circuit diagram of apparatus for monitoring one or more olfactory parameters of a sample gas or vapour, embodying the invention in its second aspect, the apparatus being shown with various valves in positions allowing flushing and purging of the apparatus;

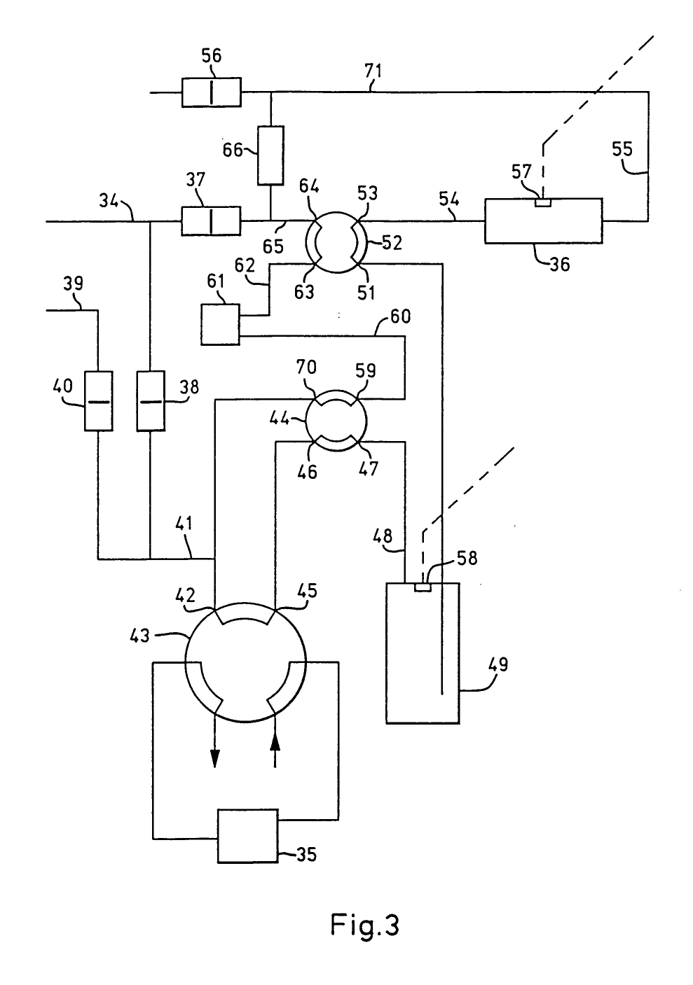

FIG. 3 shows the block circuit diagram of FIG. 2, but with the various valves set in positions to allow loading of a sample;

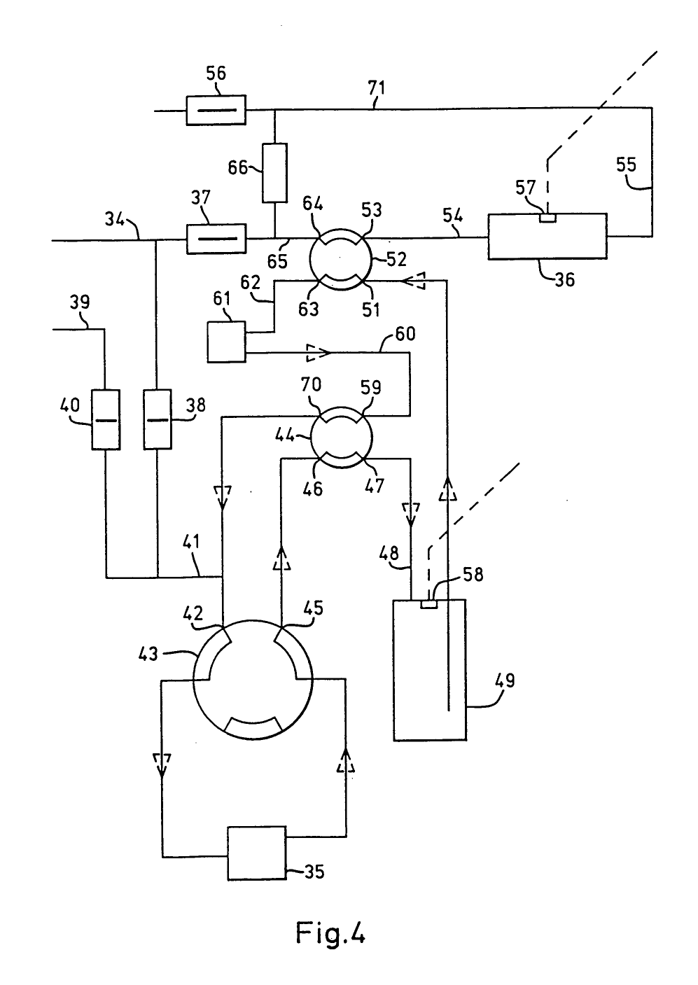

FIG. 4 shows the block circuit diagram of FIG. 2, but with the various valves set in positions to allow odour sampling;

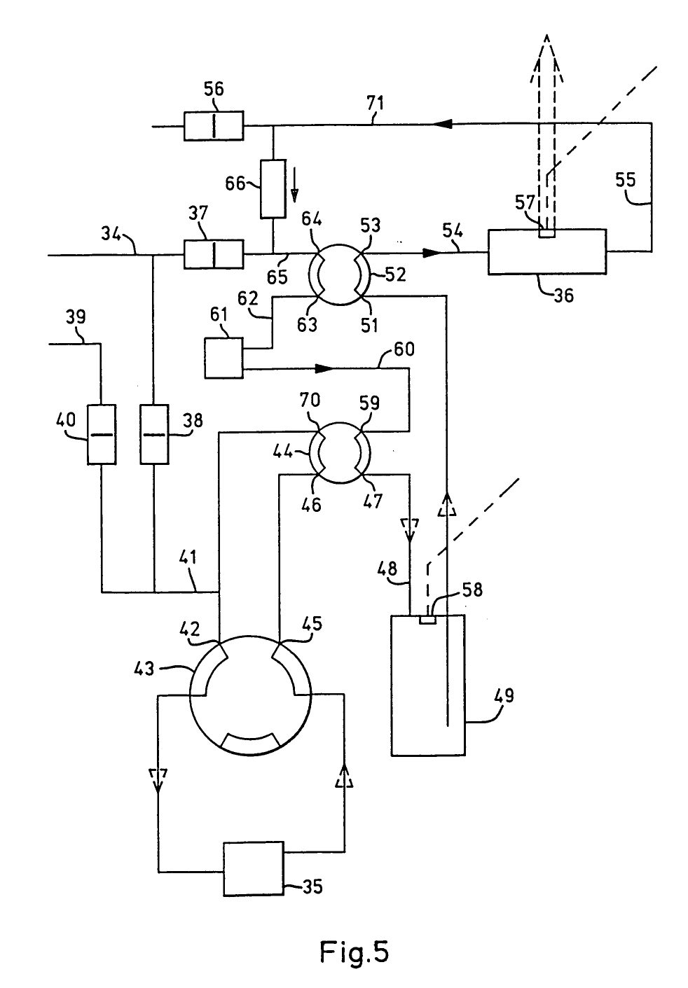

FIG. 5 shows the block circuit diagram of FIG. 2, but with the various valves set in positions to allow odour reading;

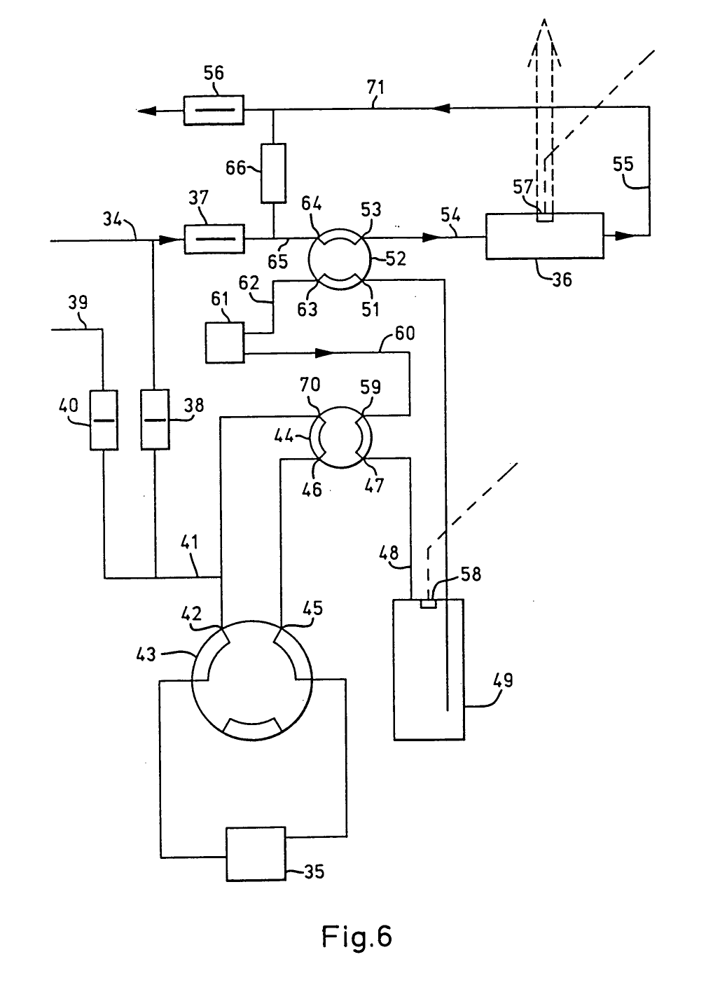

FIG. 6 shows the block circuit diagram of FIG. 2, but with the various valves set in positions to allow reading of parameters during sensor decay;

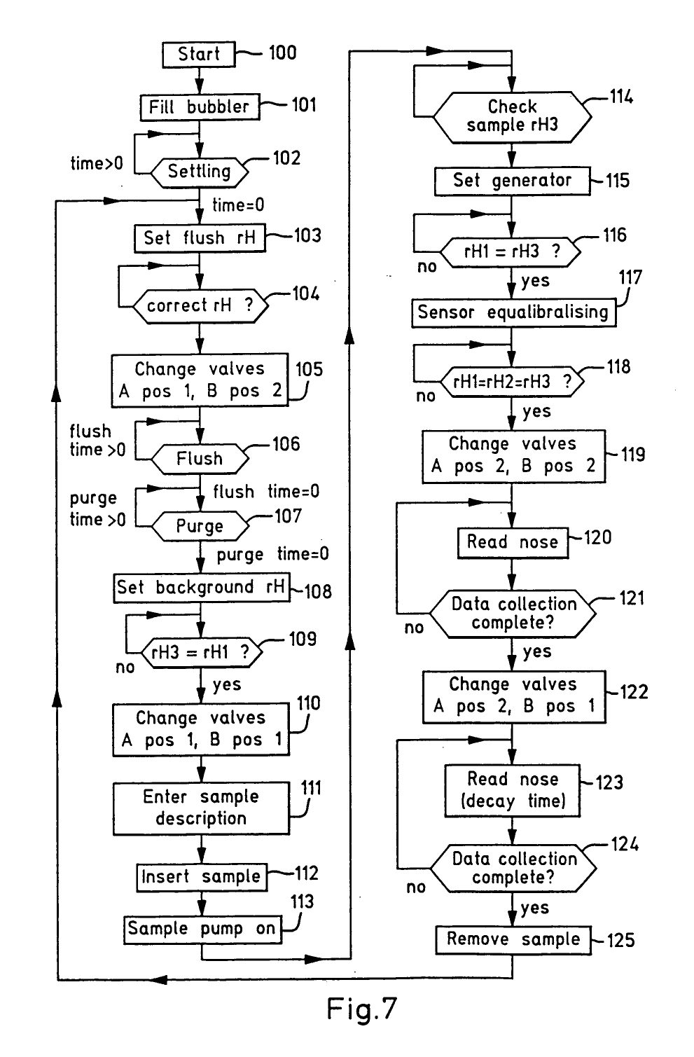

FIG. 7 is a flow chart illustrating the operation of the embodiment shown in FIGS. 2 to 6;

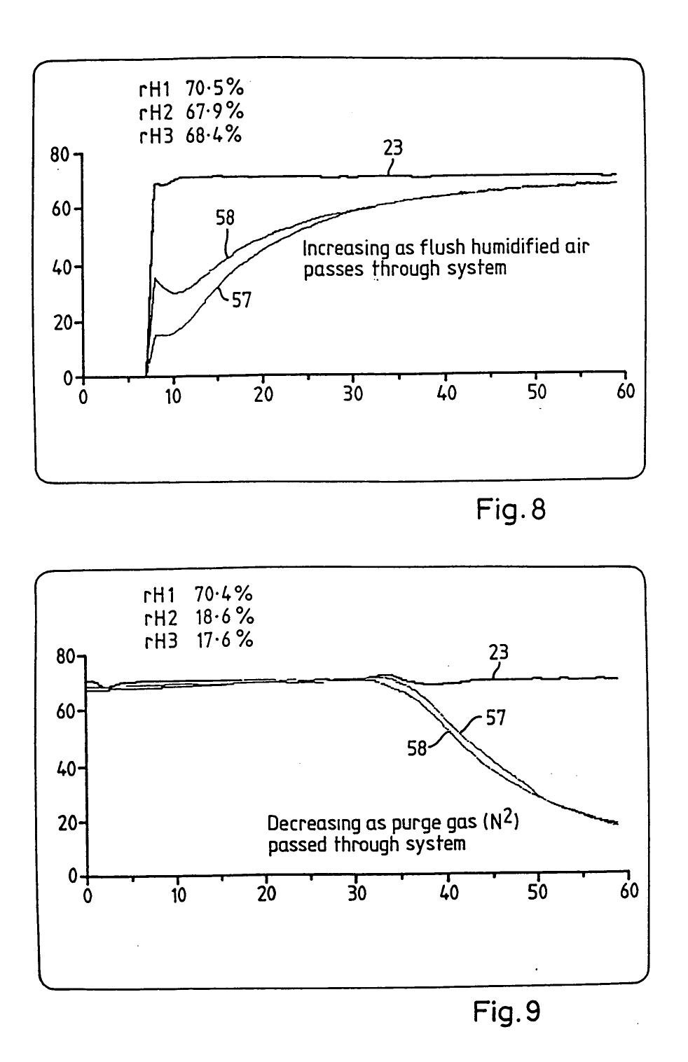

FIG. 8 is a representation of the appearance on a monitor screen of an output trace from sensors of the embodiment of FIGS. 2 to 7, showing the readings during introduction of the sample gas or vapour into the sensor chamber;

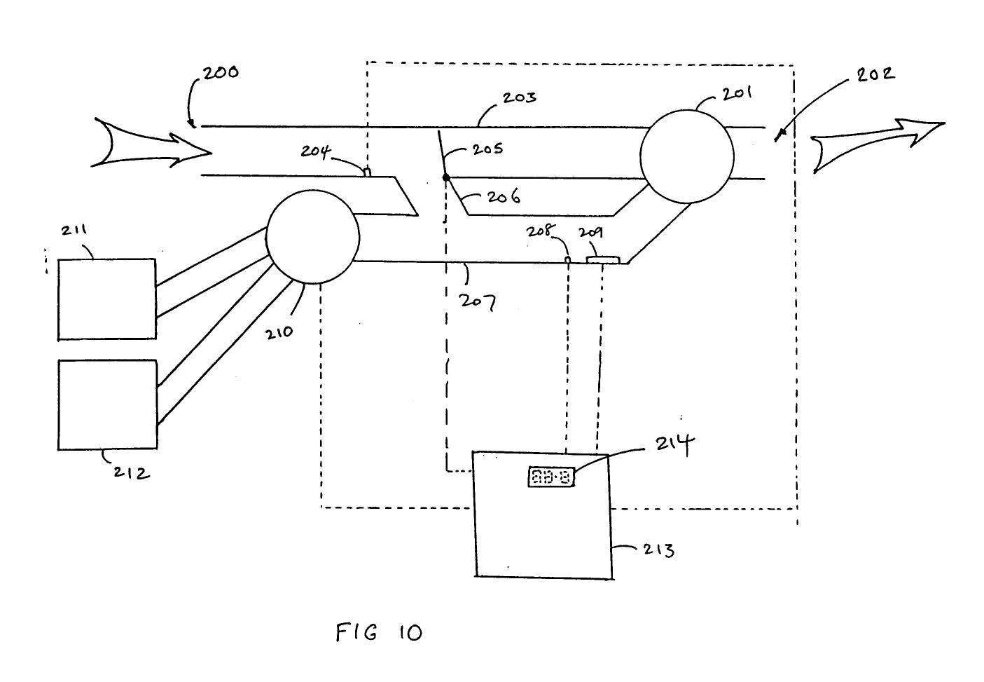

FIG. 9 is a representation of the appearance on a monitor screen of an output trace from sensors of the embodiment of FIGS. 2 to 7, showing decay of the readings of the olfactory sensors as the sample gas or vapour exits from the sensor chamber; and

FIG. 10 is a schematic diagram of a further embodiment according to the second aspect of the invention.

FIG. 1 shows apparatus embodying the invention for generating a flow of humidified air having a selected level of humidity. The generator 10 has at its inlet a pump 11 for drawing ambient air into the apparatus. A purification column 12 is connected to the output of the pump 11 and passes the air stream to a drying column 13 the outlet of which is joined to a two-way solenoid valve 14 having first and second outlets 15 and 16. The outlet 15 forms part of a first air flow path indicated generally at 17 and the second outlet 16 forms part of a second air flow path 18. The outlet 15 is connected to a variable flow restrictor or regulator 19 the output of which is connected to a common conduit 20 leading to a mixing vessel 21. The second outlet 16 is connected to the common conduit 20 through a humidifying means 22 which may be a frit submerged in water in a stainless bubbler chamber where the air flow is saturated with water vapour before entering the mixing vessel 21.

Mounted on the mixing chamber 21 is a humidity sensor which may comprise a relative humidity rH probe 23. This constitutes a first relative humidity sensor of the various embodiments of the invention. The output of the rH sensor 23 is an electrical signal representing the humidity level in the mixing vessel 21. The relative humidity sensor 23 is connected by data transfer line 24 to a microprocessor 25. The humidity level signal is also passed from the rH sensor 23 along a data transfer line 26 to a proportional integral differential controller PID 27. The PID controller also receives an input along a line 28 from the microprocessor 24. The input signal along sensor 23. The signal along the line 28 is a set humidity level signal which sets for the PID controller the target level for the humidity in the mixing vessel 21.

The output of the PID controller 27 is a control signal passing along a line 29 from the PID controller via a relay 30 to the control input of the valve 14. Valve 14 is a controllable two-way valve such that the valve can switch the input air stream from the column 13 rapidly between the first and second air flow paths 17 and 18. The controllable valve 14 has a first state arranged to direct the input air stream to the first air flow path entirely, and a second state arranged to direct the entire input stream to the second air flow path entirely. The PID controller 27 is arranged to switch the valve between states and to vary the time periods of the two states to achieve the variation in proportion in which the first and second air stream are combined. The mixing vessel 21 has a bleed to atmosphere at 31 and has an output conduit at 32 from which humidified air may be passed to further operating components.

The operation of the embodiment is as follows. Room air is pumped through the purification column 12, conveniently of activated carbon, by the diaphragm pump 11 operating at for example 600 ml/min. The resulting clean air passes through a drying column 13 to give a stream of clean dry air. This then passes through the two-way solenoid valve under the control of the PID controller 27. The valve 14 splits the air flow, one stream passing directly to the mixing chamber through a flow control valve and the other passing through the humidifier 22 before reaching the mixing chamber 21. The relative humidity probe 23 in the mixing chamber measures the humidity of the mixed streams and feeds the result to the microprocessor 25. Any desired set point is set on the microprocessor, using in-house software, and is then fed to the PID controller 27. The PID controller 27 proportions the wet/dry air flows to allow rapid ramping between set humidities without overshoot. Feedback from the rH probe 23 in the mixing chamber allows precise control of the generated humidity, and it is this closed loop feedback to the PID controller 27, related to the actual relative humidity produced by the apparatus at the mixing vessel 21, that gives substantial control to determine the wet/dry ratio required to give a desired humidity.

The flow controller 19 in the dry air flow allows the flow rate of the wet and dry streams to be balanced to smooth the pulses of air entering the mixing chamber. The output of the humidity generator is then fed on to further components, via a solenoid valve 33. To avoid pressure build-up when this valve is shut, the mixing chamber is vented to atmosphere through the conduit 31. To avoid pressure build-up when this is shut, the mixing chamber is vented to the atmosphere through the bleed conduit 31.

The operation of the PID controller 27 is such that when a rapid change is required between the set humidity level and the humidity level detected by the rH sensor 23, the valve 14 is switched to give longer periods in, say, the second state with the air flow directed to the second air flow path 18. Thus the PID controller switches the valve 14 between the two states back and forth, during ramping, but leaves the valve mainly in one or other state.

As the humidity of the air approaches the set humidity, it is found advantageous to have the valve 14 switch back and forth between the two states with time periods which are approximately the same, and in any case not differing from each other more than, say, by a factor of two. It is for this reason that the variable flow restrictor 19 is inserted in the first air flow path. If this air restrictor is not present, it is found that the additional resistance provided in the second air flow path by the humidifier 22, forces a situation where the valve 14 is held for a lengthy period in the second state while the wet air stream is fed to the mixing valve followed by a shorter period when fixed to the first state. Because of the lesser resistance in the first air flow path, sufficient dry air is provided in a short period burst, compared with the slower long period in the second state. This is found disadvantageous because the rH sensor 23 reacts strongly to the blast of dry air, and the PID controller overreacts in controlling the valve 14. The result is an overshoot when approaching the desired stable situation when the humidity level sensed at the sensor 23 is equal to the humidity level set along the line 28. To avoid this overshoot, the flow restrictor 19 can be variable, and can be adjusted until the periods in the two states are approximately the same at approach to the set humidity, or a fixed restrictor can be used selected at the appropriate value.

FIG. 2 shows a block circuit diagram of apparatus embodying the invention for monitoring a number of olfactory parameters of a sample gas or vapour, so as to provide a “finger print” of the odour from the sample. In the preferred form described, the apparatus utilises the output of the humidified air generator shown in FIG. 1, the output from the valve 33 in FIG. 1 being provided along a conduit 34 in FIG. 2. The principal components of the apparatus shown in FIG. 2 are a solid or liquid sample chamber 35 for containing a sample giving rise to the gas or vapour to be analysed: an odour chamber 49 (in effect a further sample chamber), for containing gas or vapour from the solid or liquid sample in the chamber 35; a sensor chamber 36 in which are positioned an array of olfactory sensors for measuring various parameters of the gas or vapour from the sample; and a series of valves for switching air flows between the components, for flushing, sensing and other operations.

The input conduit 34 is connected to a first valve 37 for use during humidity level setting and the decay phase of sensing, and a second valve 38, for use during flushing. A purge gas conduit 39 is available for feeding purge gas to a third, purge valve 40 the outlet of which is combined with the outlet of the flush valve 38, both of which are connected via a conduit 41 to a first port 42 of a six port valve 43. The conduit 41 is also connected to a first port 70 of a first, four port valve 44. A second port 45 of the six port valve 43 is connected to a fourth port 46 of the four port valve 44. A third port 47 of the four port valve 44 is connected to an input 48 of the odour chamber 49. An outlet of the odour chamber 49 is connected via a conduit 50 to a third port 51 of a second, four port, B, valve 52. A second port 53 is connected along a conduit 54 to the sensor chamber 36, the outlet of which is connected along a conduit 55 to a fourth valve 56 leading to atmosphere. The sensor chamber 36 has humidity sensor 58 mounted therein.

A second port 59 of the first, A valve 44, is connected along a conduit 60 to a pump 61, the outlet of which is connected along conduit 62 to a fourth port 63 of the second. B valve 52. A first port 64 is connected along a conduit 65 to the outlet of the humidity level/decay phase valve 37. A one-way valve 66 is connected between the conduits 65 and 71, in a direction to allow gas from the conduit 71 to pass to the conduit 65, when the vent valve 56 is closed

The operation of the apparatus can be divided into five main stages, corresponding to FIGS. 2 to 6. In FIG. 2 during the flush and purge stage, the valve positions are as follows.

| | |
|---|---|
| Humidity Level/Decay Phase Valve 37 | Shut |
| Flush Valve 38 | Open during flushing |
| Purge Valve 40 | Open during purging |
| Vent Valve 56 | Open |
| Multiport Valves 43, 44 and 52 | Connections made between |
| | ports as shown in the Figure. |

In FIG. 3 during the sample loading stage, the valve positions are as follows.

| | |
|---|---|
| Humidity Level/Decay Phase Valve 37 | Shut |
| Flush Valve 38 | Shut |
| Purge Valve 40 | Shut |
| Vent Valve 56 | Shut |
| Multiport Valves 43, 44 and 52 | Connections made between |
| | ports as shown in the Figure. |

In FIG. 4 during odour sampling and humidity level setting, the valve positions are as follows.

| | |
|---|---|
| Humidity Level/Decay Phase Valve 37 | Open |
| Flush Valve 38 | Shut |
| Purge Valve 40 | Shut |
| Vent Valve 56 | Open |
| Multiport Valves 43, 44 and 52 | Connections made between |
| | ports as shown in the Figure. |

In FIG. 5 during odour reading, the valve positions are as follows.

| | |
|---|---|
| Humidity Level/Decay Phase Valve 37 | Shut |
| Flush Valve 38 | Shut |
| Purge Valve 40 | Shut |
| Vent Valve 56 | Shut |
| Multiport Valves 43, 44 and 52 | Connections made between |
| | ports as shown in the Figure. |

In FIG. 6 during sample decay reading, the valve positions are as follows.

| | |
|---|---|
| Humidity Level/Decay Phase Valve 37 | Open |
| Flush Valve 38 | Shut |
| Purge Valve 40 | Open |
| Vent Valve 56 | Shut |
| Multiport Valves 43, 44 and 52 | Connections made between |
| | ports as shown in the Figure. |

The operation of the apparatus will now be described with reference to FIGS. 2 to 6. With reference to FIG. 2, the system 36 is first cleaned by flushing with 70% humidified air, the valve 38 being open. The pump 61 pumps the flushing gas through the chambers 35, 49 and 36 and out through the vent valve 56 to atmosphere.

Referring to FIG. 3, the sample to be tested is then introduced into the sample chamber 35 on a stainless steel spatula. After a settling time the humidity of the sample is measured by the third relative humidity sensor 58 with the valves positioned as in FIG. 3.

Referring to FIG. 4, at this stage the gas or vapour from the sample in the sample chamber 35 is introduced into the odour chamber 49 and the pump 61 circulates gas around the circuit shown in FIG. 4 until the humidity of the sample gas measured by the third humidity sensor 58, has stabilised. The required humidity level as measured from the third humidity sensor 58 is then set in the apparatus of FIG. 1 by the microprocessor 25 and the humidified air generator of FIG. 1 is operated until the required humidity is reached and has settled. During this period, the output stream of air from the apparatus of FIG. 1 enters along the input conduit 34, through the open valve 37, through the sensor chamber 36, and is vented to atmosphere through the valve 56. The arrangement of FIG. 4 continues until the readings on three humidity sensors are the same, that is to say the first humidity sensor 23 in FIG. 1, and the second and third humidity sensors 57 and 58 in FIG. 4.

With the valve settings as shown in FIG. 5, the sample chamber 35 is isolated and the pump 61 circulates air from the odour chamber 49 through the sensor chamber 36, and back through the one-way valve 66 to the pump 61. During this stage, the response of the sensors is recorded as this changes from the steady state (FIG. 4) whilst the humidified air from the conduit 34 passes through the sensor chamber, without sample odour, to the part of the cycle shown in FIG. 5, when the odour is circulating through the sensor chamber. FIG. 8 is a representation of the appearance of the rH generator control software screen during the flush stage of the cycle. FIG. 9 is the appearance of the screen during “purge”. In FIGS. 8 and 9, the plots are labelled with reference numerals corresponding to the respective humidity sensors 23, 57, 58. The traces of FIGS. 8 and 9 are representations of the appearance of the PC monitor at various stages through the sample cycle, and show the output from rH probes 1, 2 and 3 during these phases.

Finally, further information can be obtained from the sensor decay response, that is to say the falling signal recorded by the sensors when the odour chamber is isolated from the sensor chamber, and the presence of the odour gradually dies away as the sensor chamber is traversed by the humidified air flow from the generator shown in FIG. 1. Therefore, with the valve settings as shown in FIG. 6, the sensor responses continue to be recorded as the odour is flushed out of the sensor chamber through the open valve 56. An example of the sensor response during decay is shown in FIG. 9.

The purpose of the series of stages shown in FIGS. 2 to 6 is to obtain the balanced humidity situation shown in FIG. 4, just before the two four port valves are simultaneously moved to the position shown in FIG. 5. In this balanced position the relative humidity levels are the same at the three humidity sensors. The importance of this is that when the valves 44 and 52 are moved together to the position shown in FIG. 5, there is no drastic change in the humidity level associated with the introduction of the odour into the sensor chamber. This means that the sensor responses shown in FIGS. 8 and 9 are principally due to the introduction of the odour, and are not unduly influenced by a sudden change in humidity in the sensor chamber. It has been found that in the absence of balancing the relative humidities before introducing the odour, most of the change recorded by the olfactory sensors can be attributed to the change in humidity rather than to the introduction of the odour. Since the finger print of the odour depends upon the relatively small differences between the responses of the different sensors by the three different curves on the graph, it will be appreciated that these differences are easily lost if they are superimposed on a change of signal level several magnitudes larger, produced by a change of humidity. This does not occur in accordance with the preferred embodiment of the invention, if the humidities are balanced throughout the system before the odour is introduced into the sensor chamber.

In FIG. 7 there is shown a flow chart representing the steps which have been explained with reference to FIGS. 2 to 6. Considering briefly FIG. 7, the boxes and flow lines correspond to the steps which have been described approximately as follows. At the start box 100 the operator switches on the microprocessor which shows on the screen a reminder at box 101 to fill the humidifier. At box 102 a settling time is set to allow the humidity sensors to settle. At step 103 the operator sets the valve positions as shown in FIG. 2, for the flush cycle to commence. At box 104 a further settling time is allowed until rH1=set flush rH. When this has been achieved, at box 105 (decision box in program, “if/then”), the operator changes the position of the valves A and B to that shown in FIG. 2.

At box 106, the operator carries out the flushing cycle described with reference to FIG. 2, by flushing the humidified air through components 35, 36, 49 plus pipework plus valves. At box 107, the purging cycle described with reference to FIG. 3 is carried out, purged gas being passed through components 35, 36, 49 plus intervening pipework.

At box 108, the operator sets into the microprocessor 25 in FIG. 1 the required background humidity level. At decision box 109 a further waiting time occurs until the humidity levels at humidity sensors 58 and 23 (FIG. 1) become equal.

When this is achieved, at box 110, the operator changes simultaneously the settings of valves 44 and 52 to the position in FIG. 4. At box 111 the operator enters a description of the sample into the microprocessor for printing out on the results sheet. At box 112 the sample is inserted into the sample chamber, and at 113 the pump 61 is switched on.

At box 114 the humidity level at the sensor 58 in the odour chamber 49 is read and is then entered at box 115 into the microprocessor 25 (FIG. 1) to be set into the PID controller 27. At box 116 there is a further settling time until the humidity levels at humidity sensor 23 reaches that at sensor 58. At box 117 the sensor equalibralising step takes place, which consists of humidified air passing from the generator through chamber 36 until sensors 58, 57, 23 all read the same. At box 118 there is a further settling time until the humidity levels of all three sensors 23, 58 and 57 become equal. When this is achieved, at box 119 the operator changes simultaneously the two four port valves 44 and 52 from the positions shown in FIG. 4 to the positions shown in FIG. 5.

At box 120 the microprocessor reads and notes the outputs of the olfactory sensors, and this is done at step 121 repeatedly until the data collection is complete. When this is achieved, at box 123 the valves 44 and 52 are changed simultaneously to the positions shown in FIG. 6. The outputs of the olfactory sensors are then read again at boxes 124 and 125 until the sensor decay readings are complete. When this is done the sample is removed, at box 126, and if required the cycle is then recommenced at box 103.

An alternative embodiment is shown in schematic form in FIG. 10. This is a simplified arrangement which omits the mixing chamber and may omit the sample chamber. A different type of sensor is used, namely an infrared absorption spectrum sensor. In this case the apparatus is designed for the detection of acetone in cow's breath—an indicator of ketosis.

Apparatus, developed by one of the inventors of the present invention, is available for collecting a sample of cow's breath when the cow is in a stall. This is described in WO-A-9907216. With this apparatus it is possible to collect a series of exhalations from a cow's lungs and store them temporarily. The sampling apparatus described here may then be used to analyse the stored exhalation for acetone or other compounds.

The apparatus comprises an inlet 200 for cow breath, which is drawn in by the action of a pump 201 and exhausted from outlet 202. Between the inlet 200 and the pump 201 and outlet 202 is a first channel 203 housing a first relative humidity sensor 204 and a valve 205. The valve 205 is movable between a first position (as shown in FIG. 10) in which the first channel 203 is blocked and a divert channel 206 opened, and a second position (not shown) in which the divert channel 206 is blocked and the first channel 203 opened.

A second channel 207 runs parallel to the first and communicates with the first channel 203 via the divert channel 206. The second channel 207 contains a second sensor 208 of relative humidity, as well as an infrared absorption sensor 209. The second channel 207 communicates at one end with the pump 201 and at the other end with a proportional two-way valve 210. The two-way valve 210 communicates with a source 211 of dry air and a source 212 of humid air.

A control unit 213 receives inputs from the first and second humidity sensors and from the infrared absorption sensor 209. The unit 213 has an output to the proportional two-way valve 210 and to the valve 205 controlling the direction of flow between the divert and first channels 206, 203. The unit incorporates a display 214.

In operation, once a sufficient quantity of cow's breath has been collected by apparatus as described in WO-A-9907216, the store of breath is opened up to the inlet 200 and the pump 201 activated to draw the breath sample through the first channel 203 in a continuous stream. At this stage, the valve 205 is in a position such that the first channel is open and the divert channel 206 closed.

A few seconds is allowed for the flow in the first channel 203 to settle and for the first humidity sensor 204 to equalise. At this stage the control unit is activated and the sources 211, 212 of dry and humid air are switched on. The pump 201 is then able to draw a mixture of dry and humid air through the second channel 207, with the mix dependent on the setting of the two-way proportional valve 210.

The controller 213 receives an input from the first humidity sensor 204 and adjusts the position of the valve 210 until the second humidity sensor 208 is reading the same relative humidity as the first sensor 204.

This condition of the apparatus is maintained for a few seconds to allow the infrared sensor to stabilise in the ‘clean’ air stream from the dry and humid air sources. The valve 205 is then opened, diverting the breath sample flow into the second channel 207 via the divert channel 206. The system is again allowed to stabilise, and a reading is taken from the sensor 209 via the control unit display 214.

It will be appreciated that a system of this type is useful for facilitating the performance of other types of sensor which are affected by sensitive to humidity, including of course the olfactory sensors discussed in connection with the other embodiments.

It will also be appreciated that there are a large number of potential sources of gas or vapour which might be analysed by this type of apparatus. The embodiment shown in FIG. 10 might, for example, simply be placed in a room where it is desired to sense the presence or absence of a particular gas or vapour, and the sequence of operation outlined above carried out with the inlet 200 simply open to the atmosphere in the room. Alternatively, the apparatus might be made in the form of a portable probe.

1. A method of monitoring one or more parameters of a sample gas or vapour comprising the steps of
measuring the humidity of the sample gas or vapour,
providing a sensor chamber containing one or more sensors,
adjusting the humidity in the sensor chamber to be substantially the same as the measured humidity of the sample gas or vapour,
admitting into the sensor chamber the sample gas or vapour, and
monitoring the output of the sensor or sensors.

2. A method as claimed in claim 1 including measuring the humidity of the sample when enclosed in a sample chamber.

3. A method as claimed in claim 1 or claim 2 further comprising providing a source of gas or air at a selected humidity level and passing a flow of the said gas or air through the sensor chamber.

4. A method according to claim 3 in which the step of providing a supply of humidified air in the sensor chamber comprises generating a stream of humidified air from apparatus including a first humidity sensor for sensing the humidity of the air generated and control means operable to vary the humidity of the generated air supply and to adjust the humidity of the output air supply to be substantially equal to a predetermined humidity level entered into the control means.

5. A method according to claim 3 or claim 4 in which the step of adjusting the humidity in the sensor chamber includes measuring the humidity in the sensor chamber by a second humidity sensor, and varying the humidity of the said supply of humidified air until the humidity levels measured on the first and second humidity sensors are substantially the same as the said measured humidity of the sensor chamber.

6. A method according to any of claims 1 to 5 in which the step of measuring the humidity of the sample gas or vapour in the sample chamber is carried out by use of a third humidity sensor mounted for measuring the humidity in the sample chamber.

7. A method according to any preceding claim wherein at least one of the said sensors is an olfactory sensor.

8. Apparatus for monitoring one or more olfactory parameters of the sample gas or vapour comprising
a measuring device for measuring the humidity of the sample gas or vapour,
a device for passing humidified air through a sensor chamber containing one or more sensors, such that the humidity in the sensor chamber is adjusted to be substantially the same as the measured humidity of the sample gas or vapour,
a valve for admitting into the sensor chamber the sample gas or vapour for monitoring one or more components or parameters by the sensor or sensors.

9. Apparatus as claimed in claim 8 including a sample chamber for enclosing the sample gas or vapour.

10. Apparatus as claimed in claim 8 or claim 9 further comprising a source of gas or air at a selected humidity level and a device for passing a flow of the said gas or air through the sensor chamber.

11. Apparatus as claimed in any preceding claim wherein the sensor or sensors comprise at least one olfactory sensor.

12. Apparatus for providing a flow of humidified air having a selected humidity level, comprising:
supply means for supplying a first air stream and a second air stream to be combined together, the second air stream having a higher humidity than the first air stream,
a humidity sensor for sensing the humidity of air combined from the first and second air streams, and
control means for varying the proportions in which the first and second air streams are combined in response to a humidity level signal from the humidity sensor so as to maintain the humidity of the combined air substantially at a selected humidity.

13. Apparatus according to claim 12 wherein the supply means comprises
input means for supplying an input stream of air, and
a controllable valve for directing air from the input means to a first air flow path and to a second air flow path, the second air flow path including humidifying means for increasing the humidity of the air in the second air flow path, and the valve being controllable to vary the amount of air directed to each of the air flow paths,
the control means being arranged to control the valve in response to said humidity level signal from the humidity sensor so as to maintain the humidity of the combined air substantially at a selected humidity.

14. Apparatus according to claim 13 in which the controllable valve has a first state arranged to direct the entire input stream of air to the first air flow path and a second state arranged to direct the entire input stream of air to the second air flow path, the control means being arranged to switch the valve between states and to vary the time periods of the two states to achieve the variation in proportion in which the first and second air streams are combined.

15. Apparatus according to claim 13 or 14 in which the first air flow path includes a flow restrictor.

16. Apparatus according to claim 15 when including the features of claim 13, in which the flow restrictor is variable over a range including a restriction sufficient to balance the air flows in the first and second air flow paths.

17. Apparatus according to claim 15 when including the features of claim 14, in which the flow restrictor is a fixed restrictor introducing an air flow restriction approximately equal to the air flow restriction introduced by the humidifying means in the second air flow path.

18. Apparatus according to claims 16 or 17 in which the air flow restrictor has a fixed value, or is adjusted to a value, such that the time periods of the valve in the two states differ from each other by no more than a multiple of two, when the humidity sensed by the humidity sensor is close to a required level set by the control means.

19. Apparatus according to any of claims 12 to 18 including a mixing vessel connected to receive air from the first air stream and the second air stream, the mixing vessel having an outlet for supplying combined air to further apparatus, and the humidity sensor being mounted to sense the humidity of air in the mixing vessel.

20. Apparatus according to any of claims 12 to 19 in which the said control means comprises a microprocessor connected to receive the said humidity level signal from the humidity sensor.

21. Apparatus according to any of claims 12 to 20 in which the control means includes a proportional integral differential controller for controlling the valve in response to the said humidity level signal from the humidity sensor.

22. An assembly for analysing an exhalation comprising a sensor chamber including sensors for producing a profile of the odour of a sample placed in the chamber, and apparatus for providing humidified air as set out in any of claims 12 to 21, the humidified air apparatus being connected to supply humidified air of a selected level of humidification to the sensor chamber.

23. An assembly according to claim 22 including a second humidity sensor mounted to sense the humidity in the sensor chamber, and connected to supply a second humidity level signal to the said control means.

24. A method of providing humidified air comprising:
supplying a first air stream and a second air stream, the second air stream having a higher humidity than the first air stream,
combining air from the two air streams,
sensing the relative humidity of the combined air, and
varying the proportions in which the first and second air streams are combined in response to the said sensed humidity of the combined air, in such a manner as to maintain the humidity of the combined air substantially at a selected humidity.

25. A method according to claim 24 including
supplying an input air stream to a controllable valve for directing air from the input air stream to a first air flow path and to a second air flow path, the valve being controllable to vary the amount of air directed to each of the air flow paths,
increasing the humidity of the air in the second air flow path, and
controlling the valve in response to the said sensed humidity of the combined air, in such a manner as to maintain the humidity of the combined air substantially at a selected humidity.

26. A method according to claim 3 including providing the said humidified air stream by the steps set out in accordance with claim 25.
